(19) United States
(12) Patent Application Publication
(10) Pub. No.: US 2026/0299302 A1
(43) Pub. Date: Oct. 1, 2026

(54) VIRTUAL IMAGE DISPLAY DEVICE

(71) Applicant: SEIKO EPSON CORPORATION, Tokyo (JP)

(72) Inventor: Hitoshi OTA, SHIOJIRI-SHI (JP)

(73) Assignee: SEIKO EPSON CORPORATION, Tokyo (JP)

(21) Appl. No.: 19/575,946

(22) Filed: Mar. 24, 2026

(30) Foreign Application Priority Data
Mar. 26, 2025 (JP) 2025-051237

(51) Int. Cl. G02B 27/01

(52) U.S. Cl. CPC G02B 27/0172; G02B 2027/0112; G02B 2027/0178

(57) ABSTRACT

A virtual image display device includes a light emitting panel that transmits a light from an outside world from a direction opposite to a Z direction in a first period and emits a first color light in a second period, a liquid crystal panel that transmits the light from the outside world transmitted through the light emitting panel in the first period and generates a transmission image of the first color light emitted by the light emitting panel in the second period, and a liquid crystal panel that transmits the light from the outside world in the first period and blocks emission of the first color light emitted from the light emitting unit in the direction opposite to the Z direction in the second period.

The present application is based on, and claims priority from JP Application Serial Number 2025-051237, filed Mar. 26, 2025, the disclosure of which is hereby incorporated by reference herein in its entirety.

### BACKGROUND

### 1. Technical Field

The present disclosure relates to a virtual image display device.

### 2. Related Art

In recent years, for example, an eyeglass-shaped virtual image display device for visual recognition of an outside view through an image generated by a display panel has been proposed. Specifically, there is known a technique in which a transmission image generated by a liquid crystal panel is irradiated with light by a backlight and visually recognized by a user, and the liquid crystal panel and the backlight are set to be transparent and an outside view is visually recognized by the user (for example, see WO 2016/056298).

WO 2016/056298 is an example of the related art.

However, in the technique described above, the light by the backlight is emitted not only toward the user but also in an external direction opposite to the user. Accordingly, when viewed from people around other than the user wearing the virtual image display device, the glasses appear glowing, that is, the so-called eye glow phenomenon occurs. There is a problem that, when the eye glow phenomenon occurs, the people around the user feel as if the user wearing the virtual image display device views something and cannot make eye contact with the user.

### SUMMARY

A virtual image display device according to an aspect of the present disclosure includes a light emitting unit that transmits a light from an outside world in a first period and emits a first color light in a second period, a display unit that transmits the light from the outside world transmitted through the light emitting unit in the first period, and generates a transmission image of the first color light emitted by the light emitting unit in the second period, and a transmission and blocking switching unit that transmits the light from the outside world in the first period, and blocks the first color light emitted from the light emitting unit in the second period.

### BRIEF DESCRIPTION OF THE DRAWINGS

FIG. 1 is a perspective view showing a configuration of a virtual image display device according to a first embodiment.

FIG. 2 shows an optical configuration of the virtual image display device.

FIG. 3 is a block diagram showing the configuration of the virtual image display device according to the first embodiment.

FIG. 4 is a cross-sectional view of a main part of a liquid crystal panel in the virtual image display device.

FIG. 5 is a block diagram showing a configuration of a liquid crystal panel that generates a transmission image.

FIG. 6 shows equivalent circuits of pixel circuits in the liquid crystal panel.

FIG. 7 is a cross-sectional view of a main part of a light emitting panel in the virtual image display device.

FIG. 8 is a cross-sectional view of a main part of a liquid crystal panel that transmits or blocks light in the virtual image display device.

FIG. 9 shows an operation of the virtual image display device.

FIG. 10 shows an operation of the liquid crystal panel that generates a transmission image.

FIG. 11 shows an operation of a virtual image display device according to a modification of the first embodiment.

FIG. 12 shows an operation of a virtual image display device according to a second embodiment.

FIG. 13 is a circuit diagram showing a main part of a scanning line drive circuit in a liquid crystal panel.

FIG. 14 shows an operation of the scanning line drive circuit.

FIG. 15 shows a main part of a distribution circuit.

### DESCRIPTION OF EMBODIMENTS

An electro-optical device according to an embodiment will hereinafter be described with reference to the drawings. Note that in the drawings, dimensions and scales of the elements are appropriately made different from actual ones. The following embodiments are preferable specific examples of the present disclosure and therefore various technically preferable limitations are imposed thereon; however, the scope of the present disclosure is not limited to the embodiments unless there is a description that the present disclosure is limited thereto in particular in the following description.

A virtual image display device according to a first embodiment is the so-called head mounted display, and is of a see-through type for a user wearing the head mounted display to visually recognize a display image by a liquid crystal panel as a virtual image superimposed on a real view.

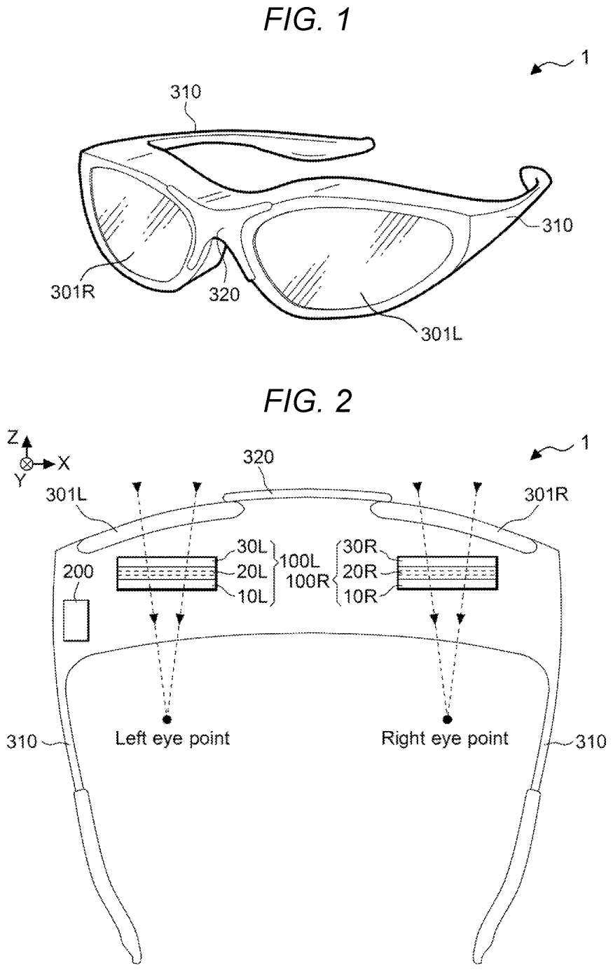

FIG. 1 is a perspective view showing a virtual image display device 1, and FIG. 2 shows an optical configuration of the virtual image display device 1. As illustrated in the drawing, the virtual image display device 1 includes temples 310, a bridge 320, and lenses 301L and 301R, similarly to general glasses. As illustrated in FIG. 2, in the virtual image display device 1, a display structure 100L for the left eye and a display structure 100R for the right eye are provided in the vicinity of the bridge 320 and at the back side (lower side in the drawing) of the lenses 301L and 301R.

When a direction in which a user visually recognizes a real view is a Z direction, the display structure 100L is a structure in which a liquid crystal panel 10L, a light emitting panel 20L, and a liquid crystal panel 30L are stacked in order toward the Z direction. Similarly to the display structure 100L, the display structure 100R is a structure in which a liquid crystal panel 10R, a light emitting panel 20R, and a liquid crystal panel 30R are stacked in order toward the Z direction.

Each of the liquid crystal panels 10L and 10R is of a transmissive type that generates a transmission image on an XY plane perpendicular to the Z direction. The light emitting panels 20L and 20R time-divisionally emit color lights of R (red), G (green), and B (blue). The liquid crystal panels 30L and 30R switch between transmission and blocking of light emitted in a direction opposite to the Z direction.

The generation of the transmission images in the liquid crystal panels 10L and 10R, the light emission in the light emitting panels 20L and 20R, and the transmission and blocking of the light in the liquid crystal panels 30L and 30R are controlled by a control circuit 200.

In the virtual image display device 1, when the display structure 100L displays a left-eye image and the display structure 100R displays a right-eye image of a stereoscopic image with parallax, it is possible to cause the user to perceive the displayed image as if the displayed image had a depth or a stereoscopic effect. The liquid crystal panels 10L and 10R may display the same image.

Although an optical system including a lens is actually provided for the user to visually recognize the display images by the display structures 100L and 100R located at close distances from the eyeballs without blurring, the illustration of the optical system is omitted in order to avoid complication of the drawing.

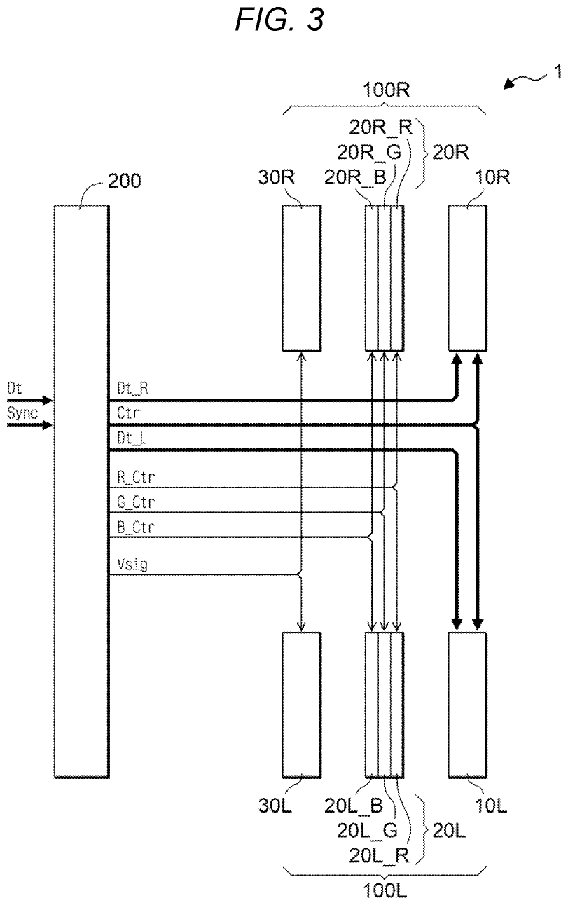

FIG. 3 is a block diagram showing a configuration of the virtual image display device 1.

The control circuit 200 receives video data Dt indicating a color video to be visually recognized by the user from a higher-level device (not illustrated) in synchronization with a synchronization signal Sync.

The control circuit 200 generates a left-eye image from the color video represented by the video data Dt, and time-divisionally supplies RGB components of the left-eye image to the liquid crystal panel 10L as a video signal Dt_L. The control circuit 200 generates a right-eye image from the color video represented by the video data Dt, and time-divisionally supplies RGB components of the right-eye image to the liquid crystal panel 10R as a video signal Dt_R. Furthermore, the control circuit 200 supplies a control signal Ctr for time-divisionally displaying images of the RGB components to the liquid crystal panels 10L and 10R.

In the present embodiment, for example, the light emitting panel 20L has a structure in which a light emitting panel 20L_R that emits a red light, a light emitting panel 20L_G that emits a green light, and a light emitting panel 20L_B that emits a blue light are sequentially stacked in the Z direction. Similarly to the light emitting panel 20L, the light emitting panel 20R has a structure in which a light emitting panel 20R_R that emits a red light, a light emitting panel 20R_G that emits a green light, and a light emitting panel 20R_B that emits a blue light are sequentially stacked in the Z direction.

The control circuit 200 supplies a control signal R_ctr for controlling the red light emission to the light emitting panels 20L_R and 20R_R, supplies a control signal G_ctr for controlling the green light emission to the light emitting panels 20L_G and 20R_G, and supplies a control signal B_ctr for controlling the blue light emission to the light emitting panels 20L_B and 20R_B.

Furthermore, the control circuit 200 outputs a control signal Vsig for controlling transmission and blocking of light in the liquid crystal panels 30L and 30R.

Since the liquid crystal panels 10L and 10R have the same structure, the liquid crystal panel 10L will be representatively described.

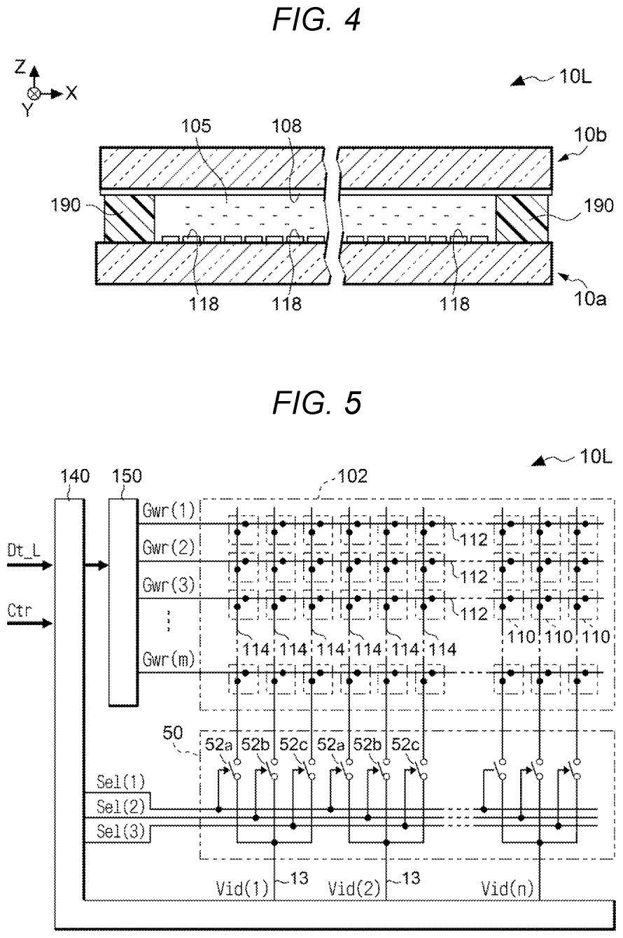

FIG. 4 is a cross-sectional view of a main part of the liquid crystal panel 10L.

In the liquid crystal panel 10L, an element substrate 10a on which pixel electrodes 118 are provided and a counter substrate 10b on which a common electrode 108 is provided are bonded to each other by sealing materials 190 such that the electrode formation surfaces face each other while maintaining a constant gap, and liquid crystal 105 is sealed in the gap.

As each of the element substrate 10a and the counter substrate 10b, a substrate having a light-transmissive property of glass, quartz, or the like is used.

In the element substrate 10a, the pixel electrodes 118 provided on the surface facing the counter substrate 10b are formed in substantially square shapes in plan view by patterning a conductive layer having transparency of indium tin oxide (ITO), for example. The pixel electrode 118 is switched by a transistor as will be described later.

In the present description, “plan view” refers to a view of the liquid crystal panel 10L from the direction opposite to the Z direction.

In the counter substrate 10b, the common electrode 108 provided on the surface facing the element substrate 10a is formed using ITO or the like.

FIG. 5 is a block diagram showing a configuration of the liquid crystal panel 10L. In the liquid crystal panel 10L, a distribution circuit 50, a display control circuit 140, and a scanning line drive circuit 150 are provided on the periphery of a rectangular display region 102.

In the display region 102, pixel circuits 110 corresponding to the pixels of an image to be displayed are arranged in a matrix. Specifically, in the display region 102, m scanning lines 112 are provided to extend in the horizontal direction in the drawing, and data lines 114 are provided to extend in the vertical direction in the drawing and to be kept electrically insulated from the scanning lines 112.

In the present embodiment, every three data lines 114 are grouped. When the number of groups is n, the total number of the data lines 114 is (3n) in the present embodiment.

The pixel circuits 110 are provided to correspond to the intersections of the m scanning lines 112 and the (3n) data lines 114. Therefore, in the present embodiment, the pixel circuits 110 are arranged in a matrix of vertical m rows ×horizontal (3n)-th columns.

Here, m is an integer of 2 or more. n is an integer of 2 or more. In the present embodiment, m<(3n).

In order to generalize and describe the rows of the scanning lines 112 and the rows in the pixel circuits 110 of the matrix array, an integer i from 1 to m is used. For example, the scanning lines 112 may be referred to as first, second, third, . . . , (i-1)-th, i-th, . . . , (m-1)-th, and m-th rows in order from the top in the drawing.

Similarly, in order to generalize and describe the columns of the data lines 114 and the columns in the pixel circuits 110 of the matrix array, an integer j from 1 to n is used. For example, in order to distinguish the data lines 114, the data lines may be referred to as first, second, third, . . . , (3j-2)-th, (3j-1)-th, (3j)-th, . . . , (3n-2)-th, (3n-1)-th, and (3n)-th columns in order from the left in the drawing.

Regarding the data lines 114 or columns, the j-th group may be described with the (3j-2)-th column in a first series, the (3j-1)-th column in a second series, and the (3j)-th column in a third series. In other words, in the j-th group, the data line 114 in the first series is the (3j-2)-th column, the data line 114 in the second series is the (3j-1)-th column, and the data line 114 in the third series is the (3j)-th column.

The display control circuit 140 controls generation of a transmission image by vertically and horizontally scanning the pixel circuits in the display region 102. Specifically, the display control circuit 140 processes the video signal Dt_L and the control signal Ctr supplied from the control circuit 200, and outputs data signals Vid(1), Vid(2), Vid(3), . . . , and Vid(n) and control signals Sel(1) to Sel(3) in addition to the control signal to the scanning line drive circuit 150.

The data signals Vid(1), Vid(2), Vid(3), . . . , and Vid(n) are supplied to the distribution circuit 50 via n data signal lines 13. The data signals Vid(1), Vid(2), Vid(3), . . . , Vid(n) will be generalized and described. The data signal Vid(j) is a signal having a voltage corresponding to the gray levels of three pixels corresponding to the intersections of the three data lines 114 belonging to the j-th group and the scanning line for horizontal scanning. In other words, the voltage of the data signal Vid(j) time-divisionally changes in the horizontal scanning period according to the gray levels of the three pixels.

The control signal Sel(1) is a signal for selecting the data line 114 in the first series. Similarly, the control signal Sel(2) is a signal for selecting the data line 114 in the second series, and the control signal Sel(3) is a signal for selecting the data line 114 in the third series.

The scanning line drive circuit 150 individually supplies scanning signals to the m rows of scanning lines 112 under the control of the display control circuit 140. Here, the scanning signal supplied to the scanning line 112 in the first row is denoted by Gwr(1), and subsequently the scanning signals supplied to the scanning lines 112 in the second, third, . . . , (i-1)-th, i-th, . . . , (m-1)-th, and the m-th rows are denoted by Gwr(2), Gwr(3), . . . , Gwr(i−1), Gwr(i), . . . , Gwr(m−1), and Gwr(m), respectively.

The display control circuit 140 outputs various control signals for controlling the scanning line drive circuits 150, but the control signals to the scanning line drive circuits 150 are not important in the present embodiment, and thus only signal paths are illustrated.

The distribution circuit 50 is a demultiplexer that distributes the data signal supplied to the data signal line 13 to the three data lines 114 according to the control signals Sel(1) to Sel(3). Specifically, in the distribution circuit 50, switches 52a, 52b, and 52c are provided in order corresponding to the first series, the second series, and the third series. The switches 52a, 52b, and 52c are N-channel type thin film transistors similar to the transistors in the pixel circuits 110. The switches 52a, 52b, and 52c will be described with a focus on the j-th group.

The data signal Vid(j) is supplied to the data signal line 13 corresponding to the j-th group. The data signal line 13 branches into three and is coupled to input terminals of the switches 52a, 52b, and 52c.

In the j-th group, the output terminal of the switch 52a in the first series is coupled to the data line 114 in the first series in the j-th group. The switch 52a is turned on and off according to the logic level of the control signal Sel(1). Specifically, the switch 52a is in an on-state when the control signal Sel(1) is at the H level, and is in an off-state when the control signal Sel(1) is at the L level.

In the present description, “on-state” of the switch or the transistor refers to a state in which ends of the switch or the source node and the drain node of the transistor are electrically coupled to be in a low impedance state. In addition, the “off state” of the switch or the transistor refers to a state in which ends of the switch or the source node and the drain node of the transistor are electrically decoupled to be in a high impedance state.

In the j-th group, the output terminal of the switch 52b in the second series is coupled to the data line 114 in the second series in the j-th group. The on-state and the off-state of the switch 52b are controlled according to the logic level of the control signal Sel(2).

In the j-th group, the output terminal of the switch 52c in the third series is coupled to the data line 114 in the third series in the j-th group. The on-state and the off-state of the switch 52c are controlled according to the logic level of the control signal Sel(3).

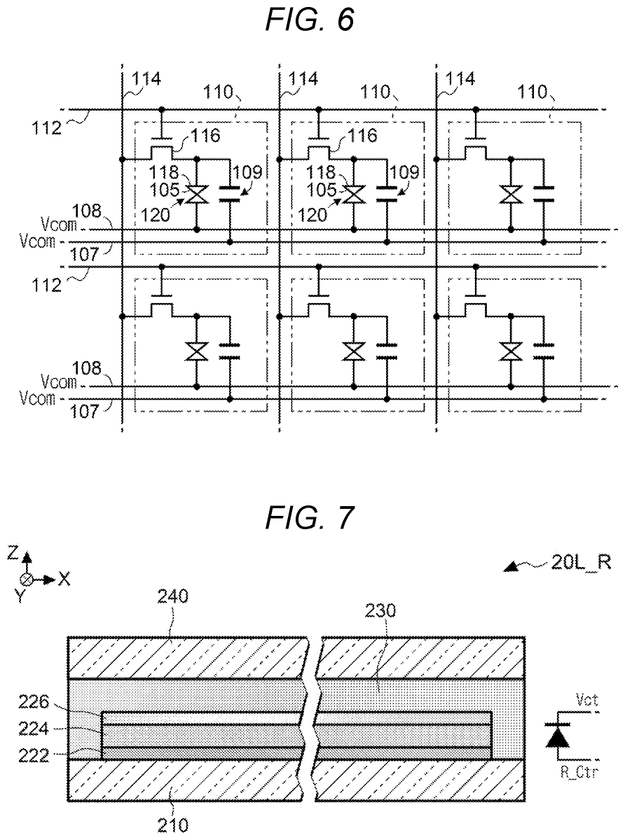

FIG. 6 shows equivalent circuits of a total of six (2×3) pixel circuits 110 corresponding to intersections of the two adjacent scanning lines 112 and the three data lines 114 belonging to the same group in the liquid crystal panel 10L.

As illustrated in the drawing, the pixel circuit 110 includes a transistor 116 and a liquid crystal element 120. The transistor 116 is, for example, an N-channel type thin film transistor. In the pixel circuit 110, the gate node of the transistor 116 is coupled to the scanning line 112, the source node thereof is coupled to the data line 114, and the drain node thereof is coupled to the pixel electrode 118 and one end of a storage capacitor 109.

In the present description, “electrical coupling” or simply “coupling” means direct or indirect coupling or joint between two or more elements, and includes, for example, coupling between two or more elements via different wiring layers and contact holes even not directly on a semiconductor substrate.

The common electrode 108 is commonly provided in all the pixel circuits 110 so as to face the pixel electrodes 118. The common electrode 108 is maintained at a temporally substantially constant voltage Vcom. The liquid crystal 105 is sandwiched between the pixel electrode 118 and the common electrode 108. Therefore, for each pixel circuit 110, the pixel electrode 118, the common electrode 108, and the liquid crystal 105 form the liquid crystal element 120.

The storage capacitor 109 is electrically coupled in parallel with the liquid crystal element 120, and the other end thereof is coupled to a capacitor wire 107. The capacitor wire 107 is maintained at a temporally constant potential, for example, the same voltage Vcom as that of the common electrode 108.

Here, the liquid crystal panel 10L is described, and the liquid crystal panel 10R is different from the liquid crystal panel 10L only in that the video signal Dt_R is supplied, and has the same configuration in other respects. When the same image is displayed on the liquid crystal panels 10L and 10R, the video signals Dt_L and Dt_R are also the same.

As described above, the light emitting panel 20L has the structure in which the light emitting panels 20L_R, 20L_G, and 20L_B are stacked. First, the light emitting panel 20L_R will be described.

FIG. 7 is a cross-sectional view of a main part of the light emitting panel 20L_R. In the light emitting panel 20L_R, an anode 222 is provided on a transparent substrate 210 having a light-transmissive property and an insulating property of glass, quartz, a film, or the like. As the anode 222, for example, a transparent conductive layer of ITO or the like is used. The anode 222 is provided with a light emitting layer 224 corresponding to red, and the light emitting layer 224 is provided with a cathode 226. As the cathode, for example, a transparent conductive layer of indium zinc oxide (IZO) is used.

A sealing layer 230 having a light-transmissive property and an insulating property is provided so as to cover the cathode 226, the light emitting layer 224, and the anode 222 for protection from moisture.

The sealing layer 230 is provided with a cover layer 340 having a light-transmissive property and an insulating property of glass, quartz, a film, or the like.

The control signal R_ctr is supplied from the control circuit 200 to the anode 222, and a voltage Vct is applied to the cathode 226. The voltage Vct is a reference ground potential at a voltage of zero.

When the control signal R_ctr becomes a voltage corresponding to on, a current flows from the anode 222 to the cathode 226, holes injected from the anode 222 and electrons injected from the cathode 226 are recombined in the light emitting layer 224, excitons are generated, and a red light is generated. The generated red light is emitted mainly in the Z direction and the direction opposite to the Z direction.

Here, the light emitting panel 20L_R is described, and the light emitting panels 20L_G and 20L_B are the same as the light emitting panel 20L_R except for the color lights emitted from the light emitting layers 224. Specifically, the light emitting layer 224 in the light emitting panel 20L_G emits a green light when a current flows, and the light emitting layer 224 in the light emitting panel 20L_B emits a blue light when a current flows.

Here, the light emitting panel 20L is described, and the light emitting panel 20R has the same configuration as the light emitting panel 20L.

Next, the liquid crystal panel 30L that switches between transmission and blocking of light will be described.

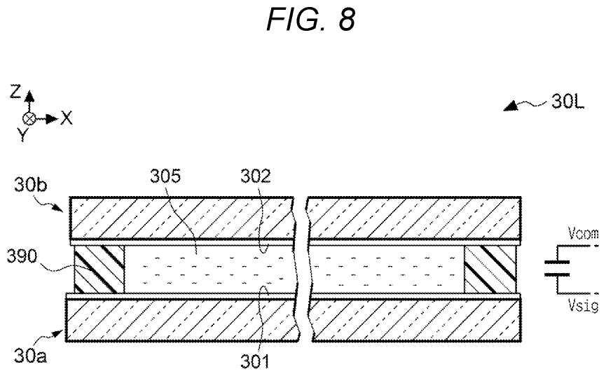

FIG. 8 is a cross-sectional view of a main part of the liquid crystal panel 30L.

In the liquid crystal panel 30L, a substrate 30a provided with an electrode 301 on one surface thereof and a substrate 30b provided with an electrode 302 on one surface thereof are bonded to each other by a sealing material 390 such that electrode formation surfaces thereof face each other while maintaining a constant gap, and liquid crystal 305 is sealed in the gap.

As each of the substrates 30a and 30b, a substrate having a light-transmissive property of glass, quartz, or the like is used. The electrodes 301 and 302 are, for example, transparent conductive layers of ITO or the like. The control signal Vsig is supplied from the control circuit 200 to the electrode 301, and the voltage Vcom is applied to the electrode 302.

The liquid crystal panel 30L is of a transmissive type and is, for example, in a normally black mode. Accordingly, when the control signal Vsig is a voltage Vwt(+) or Vwt(−), the liquid crystal panel 30L transmits light incident on the substrate 30a and emitted from the substrate 30b and light incident on the substrate 30b and emitted from the substrate 30a. In contrast, when the control signal Vsig is the voltage Vcom, the liquid crystal panel 30L blocks light incident on the substrate 30a and emitted from the substrate 30b and light incident on the substrate 30b and emitted from the substrate 30a.

In the drawing, a polarizer provided in a direction opposite to the Z direction with respect to the substrate 30a and a polarizer provided in the Z direction with respect to the substrate 30b are not illustrated.

Although the liquid crystal panel 30L has been described here, the liquid crystal panel 30R has the same configuration as the liquid crystal panel 30R.

Next, an operation of the virtual image display device 1 will be described.

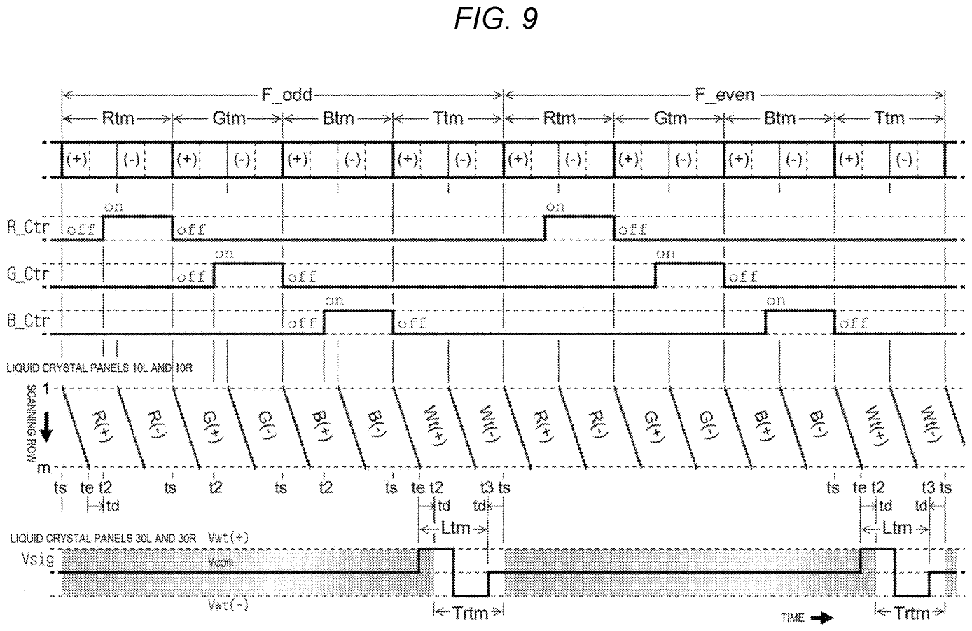

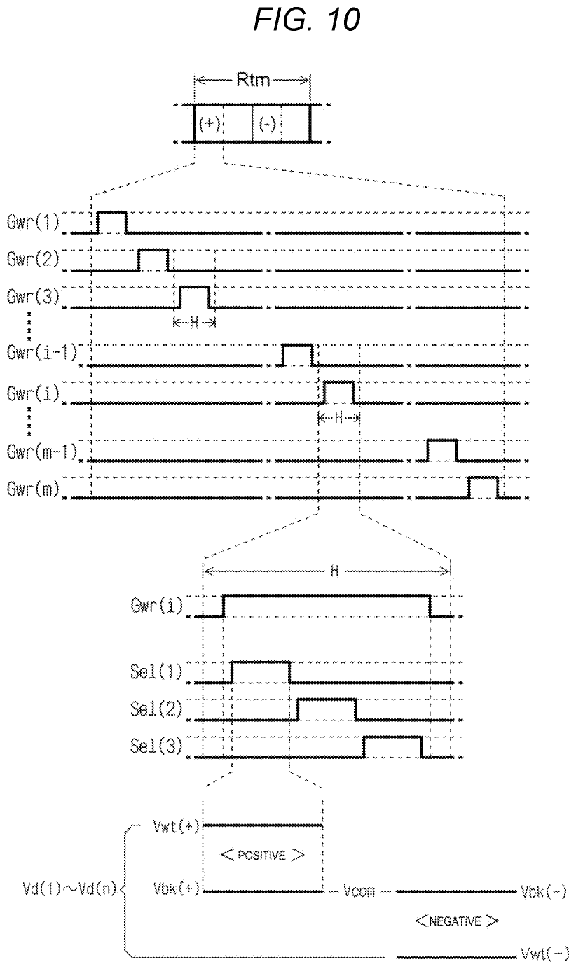

FIG. 9 shows an operation of two consecutive frames in the virtual image display device 1, and FIG. 10 is a timing chart showing an operation in a unit period Rtm in the liquid crystal panels 10L and 10R.

For the sake of convenience, the two consecutive frames are divided into a temporally preceding odd frame (F_odd) and a temporally following even frame (F_even). One frame refers to a period required to display one frame of the video image designated by the video data Dt. When the length of time of the period of one frame is the same as that of a vertical synchronization period, for example, the frequency of the vertical synchronization signal contained in the synchronization signal Sync is 60 Hz, and the length is 16.7 milliseconds corresponding to one cycle of the vertical synchronization signal.

In the first embodiment, although there is no difference in the operations between the odd frame (F_odd) and the even frame (F_even), for convenience, the two consecutive frames are divided into the odd frame (F_odd) and the even frame (F_even) in order to compare with a modification and a second embodiment described later.

In the present embodiment, the odd frame (F_odd) or the even frame (F_even) is divided into four periods of unit periods Rtm, Gtm, Btm, and Ttm.

The unit periods Rtm, Gtm, and Btm are periods for the user to time-divisionally visually recognize a red component, a green component, and a blue component of a virtual image in order and blocking the lights emitted from the light emitting panels 20L and 20R in the Z direction. The unit period Ttm is a period for the user to visually recognize the outside, that is, the outside view.

Each of the unit periods Rtm, Gtm, Btm, and Ttm is divided into two of a first half period and a second half period. The first half period is a period in which a positive data signal is written in the liquid crystal panels 10L and 10R, and the second half period is a period in which a negative data signal is written in the liquid crystal panels 10L and 10R.

The writing period of the data signal refers to a period for applying the data signal to the pixel electrode 118 of the liquid crystal element 120 via the data line 114, that is, a period for writing. The positive data signal refers to a data signal having a voltage equal to or higher than the voltage Vcom applied to the common electrode 108, and the negative data signal refers to a data signal having a voltage equal to or lower than the voltage Vcom.

When both the liquid crystal panels 10L and 10R are in the normally black mode, the transmittance of the liquid crystal element 120 increases as the difference between the voltage Vcom of the common electrode 108 and the voltage of the data signal applied to the pixel electrode 118 increases.

Specifically, as illustrated in FIG. 10, positive data signals Vd(1) to Vd(n) are the voltage Vcom when the transmittance of the liquid crystal element 120 is to be minimized, that is, when the display gray level is the minimum value, and become higher than the voltage Vcom as the transmittance increases, that is, as the display gray level increases. The positive data signals Vd(1) to Vd(n) become the voltage Vwt(+) when the transmittance of the liquid crystal element 120 is to be maximized, that is, when the display gray level is the maximum value.

The negative data signal Vd(j) is the voltage Vcom when the display gray level is the minimum value, and becomes lower than the voltage Vcom as the display gray level increases. The negative data signal Vd(j) becomes the voltage Vwt(−) when the display gray level is the maximum value.

Although the reference voltage of the polarity is the voltage Vcom of the common electrode 108, a voltage slightly higher than the voltage Vcom may be used as a reference in consideration of feedthrough generated in the N-channel type transistor. In addition, the data signal Vd(j) when the display gray level is the lowest value is not necessarily the reference voltage of the polarity.

In order to balance that the voltages Vwt(+) and Vwt(−) are voltages having the maximum transmittance, the voltage Vcom when the display gray level is the minimum value may be referred to as a positive voltage Vbk(+) or a negative voltage Vbk(−).

Unlike the liquid crystal panels 10L and 10R, the liquid crystal panels 30L and 30R transmit or block the lights emitted from the light emitting panels 20L and 20R without gray level representation. Accordingly, the liquid crystal panels 30L and 30R transmit light when the control signal Vsig is the positive voltage Vwt(+) or the negative voltage Vwt(−), and block light when the control signal Vsig is the voltage Vcom.

In the liquid crystal panels 10L and 10R illustrated in FIG. 9, the vertical axis indicates the number of rows of the scanning lines 112 from the first row to the m-th row, and the temporal transition of the selected scanning line 112 is illustrated. When the selection of the scanning line 112 is indicated by a black thick line, the scanning line 112 is exclusively selected row by row, and the selected scanning line 112 sequentially shifts from the first row to the m-th row as time elapses.

The control circuit 200 outputs the following control signals R_Ctr, G_Ctr, and B_Ctr.

Specifically, the control signal R_Ctr instructs light emission (on) of the light emitting panels 20L_R and 20R_R at a timing t2 after a lapse of a time td from a timing te when the scanning line 112 of the last m-th row is selected in the first half period of the unit period Rtm, and instructs turn-off (off) at a timing ts when the scanning line 112 of the first row is selected in the first half period of the next unit period Gtm.

The control signal G_Ctr instructs light emission (on) of the light emitting panels 20L_R and 20R_R at the same timing t2 in the first half period of the unit period Gtm, and instructs turn-off (off) at the same timing ts in the first half period of the next unit period Btm.

The control signal B_Ctr instructs the light emission (on) of the light emitting panels 20L_R and 20R_R at the same timing t2 in the first half period of the unit period Btm, and instructs turn-off (off) at the same timing ts in the first half period of the next unit period Ttm.

The time td is a delay time from when the voltage of the data signal is applied to the pixel electrode 118 to when the transmittance corresponding to the voltage is reached in the liquid crystal elements 120 of the liquid crystal panels 10L and 10R. In practice, the time td may be different between a case where the transmittance of the liquid crystal element 120 is higher (lighter) and a case where the transmittance is lower (darker), but the time td is treated as the same in order to simplify the description.

The control circuit 200 outputs the following control signal Vsig.

Specifically, the control signal Vsig becomes the voltage Vwt(+) at a timing te when the scanning line 112 of the last m-th row is selected in the first half period of the unit period Ttm, becomes the voltage Vwt(−) by inverting the polarity at a timing at the half the period Ltm, and becomes the voltage Vcom at a timing t3.

The timing t3 is a timing preceding the timing ts when the scanning line 112 of the first row is selected by the time td in the first half period of the unit period Rtm by the time td. The period Ltm is a period from the timing te to the timing t3 in the unit period Ttm.

In the unit periods Rtm, Gtm, and Btm, the operations of the liquid crystal panels 10L and 10R are different only in the color component of the supplied data signal, and the other operations are common. Therefore, the operations in the unit periods Rtm, Gtm, and Btm will be described by taking the unit period Rtm as an example.

Specifically, as shown in FIG. 10, the scanning signals Gwr(1), Gwr(2), . . . , Gwr(i−1), Gwr(i), . . . , Gwr(m-1), and Gwr(m) are sequentially and exclusively at the H level for each horizontal scanning period (H) by the scanning line drive circuit 150. The horizontal scanning period (H) is a time interval in which the scanning signals Gwr(1) to Gwr(m) are sequentially at the H level.

In the embodiment, periods in which adjacent scanning signals among the scanning signals Gwr(1) to Gwr(m) are at the H level are temporally isolated from each other. Specifically, after the scanning signal Gwr(i−1) changes from the H level to the L level, the next scanning signal Gwr(i) changes from the L level to the H level.

The control signals Sel(1) to Sel(3) are sequentially and exclusively at the H level in a period in which the scanning signals Gwr(1) to Gwr(m) are at the H level.

In the period in which the scanning signal Gwr(i) is at the H level and the control signal Sel(1) is at the H level, the display control circuit 140 outputs the data signal Vid(j) having the positive voltage according to the display gray level of the red component among the display pixels corresponding to the pixel circuits 110 of the i-th row and the (3j-2)-th column.

When the scanning signal Gwr(i) is at the H level, the transistor 116 is turned on in the pixel circuit 110 of the i-th row and the (3j-2)-th column. In this state, when the control signal Sel(1) is at the H level, the switch 52a of the distribution circuit 50 is turned on, and thus the data signal Vid(j) is supplied to the data line 114 of the (3j-2)-th column. Therefore, the data signal Vid(j) supplied to the data line 114 reaches the pixel electrode 118 via the transistor 116 in the on-state in the pixel circuit 110 of the i-th row and the (3j-2)-th column, that is, the voltage of the data signal Vid(j) is applied to the pixel electrode 118. Thereafter, the control signal Sel(1) is at the L level, and the switch 52a changes to the off-state, but the voltage of the data signal Vid(j) applied to the pixel electrode 118 is held by the capacitive property of the liquid crystal element 120 and the storage capacitor 109.

Then, the control signal Sel(2) is at the H level. In the period in which the control signal Sel(2) is at the H level, the display control circuit 140 outputs the data signal Vid(j) having the positive voltage according to the display gray level of the red component among the display pixels corresponding to the pixel circuits 110 of the i-th row and the (3j-1)-th column. When the control signal Sel(2) is at the H level, the switch 52b of the distribution circuit 50 is turned on, and thus the data signal Vid(j) is supplied to the data line 114 of the (3j-1)-th column. Therefore, the voltage of the data signal Vid(j) supplied to the data line 114 is applied to the pixel electrode 118 via the transistor 116 in the on-state in the pixel circuit 110 of the i-th row and the (3j-1)-th column. Thereafter, the control signal Sel(2) is at the L level, and the switch 52b changes to the off-state, but the voltage of the data signal Vid(j) applied to the pixel electrode 118 is held by the capacitive property of the liquid crystal element 120 and the storage capacitor 109.

The control signal Sel(3) is at the H level. In the period in which the control signal Sel(3) is at the H level, the display control circuit 140 outputs the data signal Vid(j) having the positive voltage according to the display gray level of the red component among the display pixels corresponding to the pixel circuit 110 of the i-th row and the (3j)-th column. When the control signal Sel(3) is at the H level, the switch 52c of the distribution circuit 50 is turned on, and thus the data signal Vid(j) is supplied to the data line 114 of the (3j)-th column. Accordingly, the voltage of the data signal Vid(j) supplied to the data line 114 is applied to the pixel electrode 118 via the transistor 116 in the on-state in the pixel circuit 110 of the i-th row and the (3j)-th column. Thereafter, the control signal Sel(3) is at the L level, and the switch 52c changes to the off-state, but the voltage of the data signal Vid(j) applied to the pixel electrode 118 is held by the capacitive property of the liquid crystal element 120 and the storage capacitor 109.

Here, in the horizontal scanning period (H) in which the scanning signal Gwr(i) is at the H level, the pixel circuits 110 of the i-th row and the (3j-2)-th column, the i-th row and the (3j-1)-th column, and the i-th row and the (3j)-th column belonging to the j-th group have been described, but the same operation is performed in the other groups. The operation in the horizontal scanning period (H) is executed in the order of the first, second, third, . . . , and m-th rows.

Although the liquid crystal panel 10L has been described here, since the control signal Ctr is shared with the liquid crystal panel 10R, a transmission image of the video image of the red component is generated based on the video signal Dt_R also in the liquid crystal panel 10R.

In this manner, in the first half period of the unit period Rtm, a transmission image in the red component of the left-eye image is generated in the liquid crystal panel 10L, and a transmission image in the red component of the right-eye image is generated in the liquid crystal panel 10R.

For the user to visually recognize the transmission images of the red component by the liquid crystal panels 10L and 10R, the control circuit 200 supplies the control signal R_Ctr for instructing light emission to the light emitting panels 20L_R and 20R_R.

In the liquid crystal panels 10L and 10R, the change characteristics of the optical state (transmittance) with respect to the voltage change of the liquid crystal element 120 are slower than those of the light emitting panels 20L and 20R. Here, in the liquid crystal element 120, it is assumed that a delay by the time td occurs from when the voltage corresponding to the display gray level is applied to the pixel electrode 118 to when transmittance corresponding to the voltage is obtained.

In this case, at the timing t2 delayed by the time td from the timing te when the last m-th row of the scanning lines 112 is selected, the control circuit 200 outputs the control signal R_Ctr for instructing to turn on the light emitting panels 20L_R and 20R_R to generate red lights.

Accordingly, the transmission image generated by the liquid crystal panel 10L is visually recognized by the left eye of the user through the coloring of the red light by the light emitting panel 20L_R, and the transmission image generated by the liquid crystal panel 10R is visually recognized by the right eye of the user through the coloring of the red light by the light emitting panel 20R_R.

The red lights generated by the light emitting panels 20L_R and 20R_R are emitted not only in the direction opposite to the Z direction, which is the direction toward the user, but also in the Z direction, and in the unit period Rtm, the liquid crystal panels 30L and 30R are in the non-transmissive state in which the transmittance is minimized, that is, the lights are blocked, according to the control signal Vsig of the voltage Vcom.

Therefore, the red lights generated in the light emitting panels 20L_R and 20R_R in the unit period Rtm are not emitted to the outside of the virtual image display device 1.

In the second half period of the unit period Rtm, the same operation as the first half period is performed except that the data signals Vid(1) to Vid(n) are output with negative polarity. Therefore, the voltage of the negative data signal is applied to the liquid crystal element 120 in the second half period of the unit period Rtm, and thus the liquid crystal element 120 is AC-driven together with the application of the voltage of the positive data signal in the first half period.

In the second half period of the unit period Rtm, the data signals Vid(1) to Vid(n) have negative polarity, but the absolute value of the voltage applied to the liquid crystal element 120 does not change, and thus the transmittance due to the positive voltage writing in the first half period is not changed.

In the unit period Gtm, the same operation as that in the unit period Rtm is performed except that the color component of the data signal and the control signal for instructing light emission are different. That is, in the unit period Gtm, a transmission image in the green component of the left-eye image is generated in the liquid crystal panel 10L, and a transmission image in the green component of the right-eye image is generated in the liquid crystal panel 10R.

The control circuit 200 outputs the control signal G_Ctr for instructing to turn on the light emitting panels 20L_G and 20R_G to generate green lights from the timing t2 to the timing ts when the next unit period Btm starts.

Accordingly, the transmission image generated by the liquid crystal panel 10L is visually recognized by the left eye of the user through the coloring of the green light by the light emitting panel 20L_G, and the transmission image generated by the liquid crystal panel 10R is visually recognized by the right eye of the user through the coloring of the green light by the light emitting panel 20R_G.

The voltage of the positive data signal is applied to the liquid crystal element 120 in the first half period of the unit period Gtm, and the voltage of the negative data signal is applied to the liquid crystal element 120 in the second half period, and thus the liquid crystal element is AC-driven.

In the unit period Btm, the same operation as those in the unit periods Rtm and Gtm is performed except that the color component of the data signal and the control signal for instructing light emission are different. That is, in the unit period Btm, a transmission image in the blue component of the left-eye image is generated in the liquid crystal panel 10L, and a transmission image in the blue component of the right-eye image is generated in the liquid crystal panel 10R.

The control circuit 200 outputs the control signal B_Ctr for instructing to turn on the light emitting panels 20L_B and 20R_B to generate blue lights from the timing t2 to the timing ts when the next unit period Ttm starts.

Accordingly, the transmission image generated by the liquid crystal panel 10L is visually recognized by the left eye of the user through coloring with blue light by the light emitting panel 20L_B, and the transmission image generated by the liquid crystal panel 10R is visually recognized by the right eye of the user through coloring with blue light by the light emitting panel 20R_B.

The voltage of the positive data signal is applied to the liquid crystal element 120 in the first half period of the unit period Btm, and the voltage of the negative data signal is applied to the liquid crystal element 120 in the second half period, and thus the liquid crystal element is AC-driven.

As described above, in the unit periods Rtm, Gtm, and Btm, the images of the red component, the green component, and the blue component color sequentially reach the eyes of the user, the user can visually recognize the images as a color image.

In the unit periods Rtm, Gtm, and Btm, the control signal Vsig is the voltage Vcom, and thus the liquid crystal panels 30L and 30R are in the non-transmissive state. Therefore, the lights generated by the light emitting panels 20L and 20R are not emitted from the virtual image display device 1 to the outside in the Z direction.

Subsequently, the unit period Ttm for the user to visually recognize the outside view will be described.

In the unit period Ttm, in the liquid crystal panels 10L and 10R, the same operation as those in the unit periods Rtm, Gtm, and Btm is performed except that the data signal has a voltage unrelated to the video signals Dt_L and Dt_R. Specifically, the display control circuits 140 of the liquid crystal panels 10L and 10R set the data signals Vid(1) to Vid(n) at the positive voltage Vwt(+) that maximizes the transmittance in the first half period of the unit period Ttm and at the negative voltage Vwt(−) that maximizes the transmittance in the second half period.

In the unit period Ttm, the control circuit 200 sets all of the control signals R_Ctr, G_Ctr, and B_Ctr to at the level fir instructing to turn off.

Further, the control circuit 200 sets the control signal Vsig supplied to the liquid crystal panels 30L and 30R at the voltage Vwt(+) at the timing te, at the voltage Vwt(−) at the timing in the middle of the period Ltm, and at the voltage Vcom at the timing t3.

In the liquid crystal panels 30L and 30R, the change characteristics of the optical state (transmittance) with respect to the voltage change of the control signal Vsig are slower than those of the light emitting panels 20L and 20R, but the change characteristics of the optical state in the liquid crystal panels 30L and 30R are considered to be equivalent to those of the liquid crystal panels 10L and 10R.

Therefore, in the present embodiment, the timing when the voltage Vwt(+) is applied to the liquid crystal panels 30L and 30R is set to the timing te when the last m-th row is selected. Accordingly, the timing when the liquid crystal panels 30L and 30R are in the transmissive state substantially coincides with the timing t2 when all the liquid crystal elements 120 are in the transmissive state in the liquid crystal panels 10L and 10R.

The control signal Vsig becomes the voltage Vcom at the timing t3 preceding the timing ts when the next unit period Gtm starts (the timing when the scanning line 112 in the first row is selected in the first half period) by the time td. Therefore, the timing when the transmittance of the liquid crystal panels 30L and 30R is the minimum value is delayed by the time td, and thus coincides with the timing ts when the unit period Rtm in the next frame starts.

As a result, the period Trtm when the liquid crystal panels 30L and 30R are in the transmissive state is shown without hatching in FIG. 9, and has a relationship delayed by the time td required for an optical response to the voltage change with respect to the period Ltm in which the control signal Vsig is the voltage Vwt(+) or Vwt(−).

In FIG. 9, the hatched period indicates a period in which the liquid crystal panels 30L and 30R block light.

In the unit period Ttm, the liquid crystal panels 10L, 10R, 30L, and 30R are in the transmissive state, and the light emitting panels 20L and 20R are in the non-light emitting state, so that the user can visually recognize the outside view.

As described above, in the present embodiment, in the unit periods Rtm, Gtm, and Btm, the color sequential image of the red component, the green component, and the blue component can be visually recognized as a color image, and in the unit period Ttm, the outside view can be visually recognized in a see-through manner. Further, in the unit periods Rtm, Gtm, and Btm, the liquid crystal panels 30L and 30R are in the non-transmissive state, and thus it is possible to prevent the lights generated in the light emitting panels 20L and 20R from being emitted to the outside.

In the first embodiment, the first half periods of the unit periods Rtm, Gtm, Btm, and Ttm are the positive writing periods and holding periods, the second-half periods are the negative writing periods and holding periods, and the positive holding periods and the negative holding periods have the same period lengths, but the following modification in which each unit period is not divided into the first half period and the second half period may be adopted.

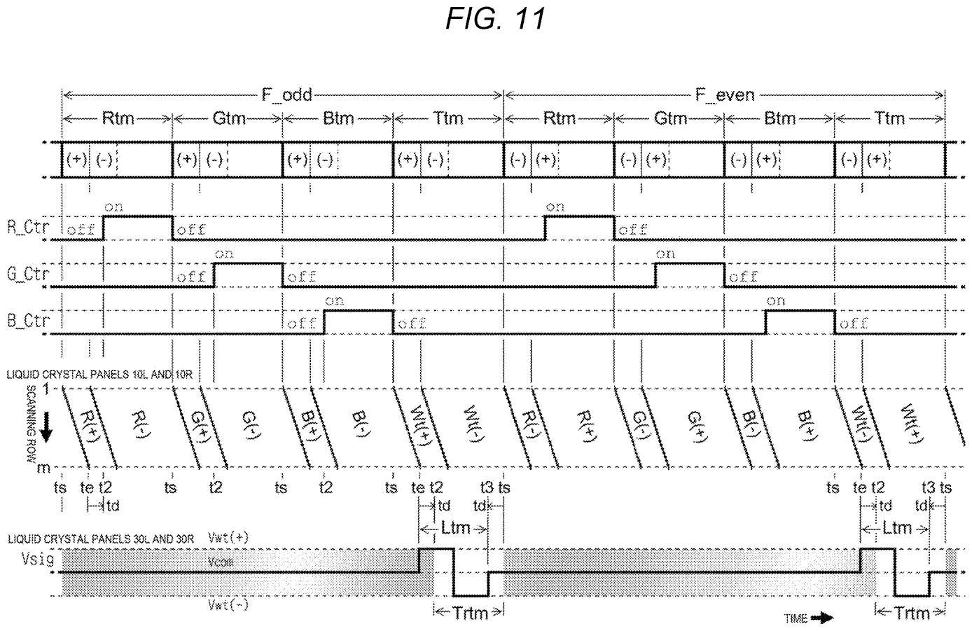

FIG. 11 shows an operation of two consecutive frames in a virtual image display device 1 according to a modification of the first embodiment.

In the modification, the unit periods Rtm, Gtm, Btm, and Ttm are not divided into the first half periods and the second half periods, but in the odd frame (F_odd), the positive writing period is followed by the negative writing period, and in the even frame (F_even), the negative writing period is followed by the positive writing period.

That is, in the modification, since the negative holding period is longer and a DC component is applied in the odd frame (F_odd), in order to cancel the application of the DC component, the positive holding period is set to be longer in the even frame (F_even).

In the modification, the operations of the light emitting panels 20L and 20R and the liquid crystal panels 30L and 30R are the same as those in the first embodiment.

Next, a second embodiment for a user to visually recognize a real image that is an outside view lighter will be described.

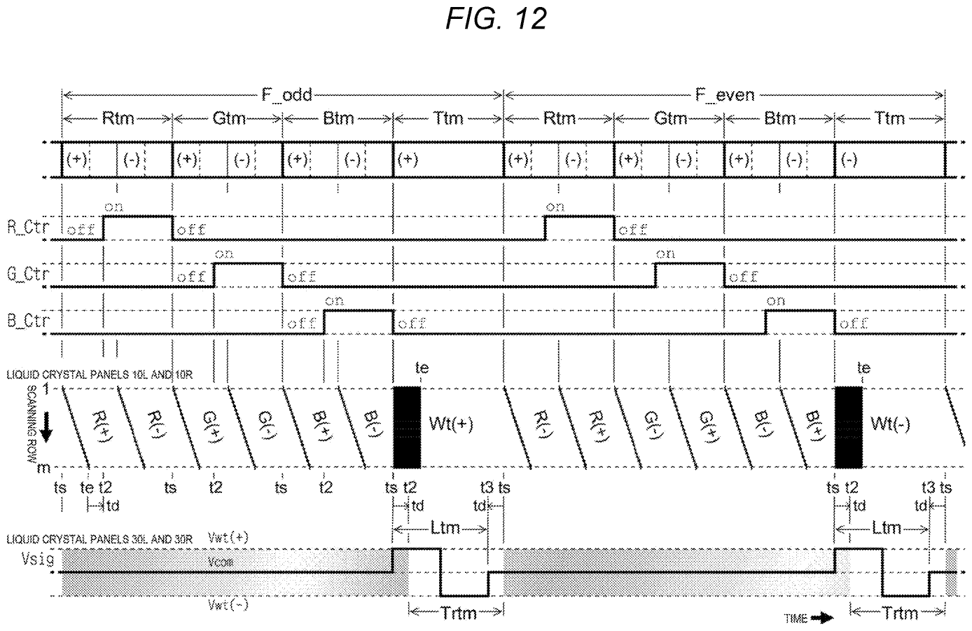

FIG. 12 shows an operation of a virtual image display device 1 according to the second embodiment.

The second embodiment is different from the first embodiment shown in FIGS. 5 and 9 in the structures of the liquid crystal panels 10L and 10R and the operations of the liquid crystal panels 10L, 10R, 30L, and 30R in the unit period Ttm.

For convenience of description, the structures of the liquid crystal panels 10L and 10R will be described first.

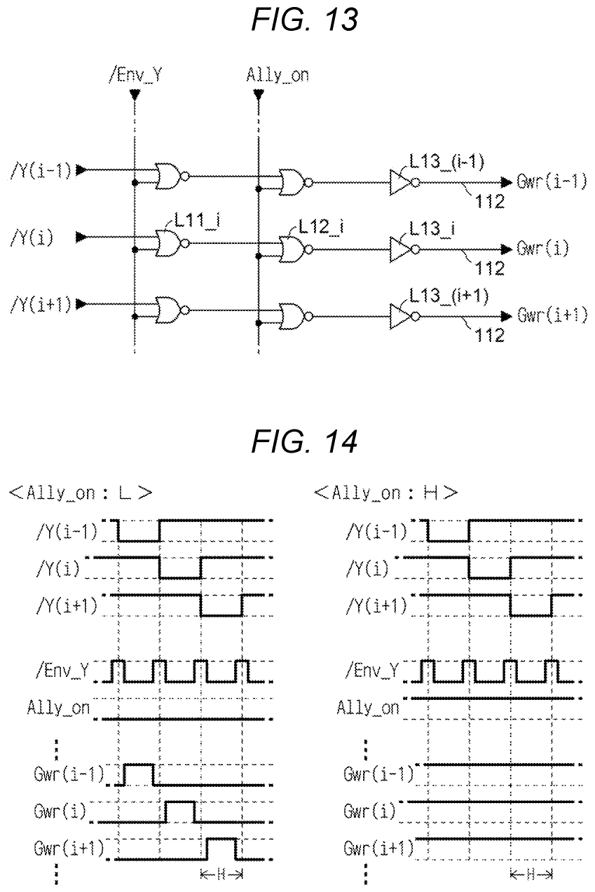

FIG. 13 is a circuit diagram showing a main part of the scanning line drive circuit 150 in the liquid crystal panels 10L and 10R. Specifically, the drawing shows a configuration of a final stage in which scanning signals Gwr(i−1), Gwr(i), and Gwr(i+1) for three rows are output in the scanning line drive circuit 150.

In the i-th row as a representative, one of the two input terminals in a NOR circuit L11_i is supplied with a negative logic pulse/Y (i) output to correspond to the i-th row in a shift register (not illustrated). The control signal/Env_Y output from the display control circuit 140 is supplied to the other input terminal of the NOR circuit L11_i.

Note that the control signal/Env_Y is commonly supplied not only to the i-th row but also to each row.

The output terminal of the NOR circuit L11_i is coupled to one of the two input terminals in a NOR circuit L12_i. A control signal Ally_on output from the display control circuit 140 is supplied to the other input terminal of the NOR circuit L12_i.

The control signal Ally_on is commonly supplied not only to the i-th row but also to each row.

The output terminal of the NOR circuit L12_i is coupled to the input terminal in a NOT circuit L13_i. The NOT circuit L13_i inverts the logic level of the signal supplied to the input terminal, and outputs the inverted signal to the scanning line 112 of the i-th row as the scanning signal Gwr(i).

FIG. 14 shows an operation of the scanning line drive circuit 150.

In the unit periods Rtm, Gtm, and Btm, the display control circuit 140 outputs the control signal Ally_on at the L level. Accordingly, in the unit periods Rtm, Gtm, and Btm, the pulses/Y(i−1), /Y (i), and/Y(i+1) which are sequentially transferred and exclusively at the L level are limited to the pulse width at the L level in the control signal/Env_Y, and then, with the logic levels inverted by NOT circuits L13_(i−1), L13_(i), and L13_(i+1), are output as the scanning signals Gwr(i), Gwr(i), and Gwr(i+1) for which the periods at the H level are temporally isolated.

In the unit periods Rtm, Gtm, and Btm, the display control circuit 140 outputs the control signal Ally_on at the L level. Accordingly, in the unit periods Rtm, Gtm, and Btm, the pulses/Y(i−1), /Y (i), and/Y(i+1) which are sequentially transferred and exclusively at the L level are limited to the pulse width at the L level in the control signal/Env_Y, and then, with the logic levels inverted by NOT circuits L13_(i−1), L13_(i), and L13_(i+1), are output as the scanning signals Gwr(i), Gwr(i), and Gwr(i+1) for which the periods at the H level are temporally isolated.

In the second embodiment, there is no second half period of the unit period Ttm. In the unit period Ttm, the display control circuit 140 outputs the control signal Ally_on at the H level from the timing ts when the scanning line 112 in the first row is selected to the timing te when the scanning line 112 in the m-th row is selected in the first half period.

When the control signal Ally_on is at the H level, the NOR circuits L12_(i−1), L12_(i), and L12_(i+1) output the L level regardless of the pulses/Y(i−1), /Y (i), and/Y(i+1) and the control signal/Env_Y.

Accordingly, the NOT circuits L13_(i−1), L13_(i), and L13_(i+1) output the scanning signals Gwr(i−1), Gwr(i), and Gwr(i+1) at the H level in the period in which the control signal Ally_on is at the H level.

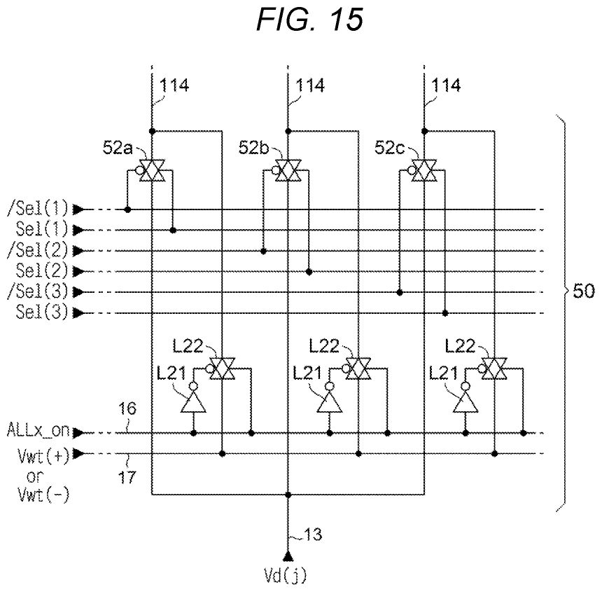

FIG. 15 is a circuit diagram showing a main part of the distribution circuit 50 in the liquid crystal panels 10L and 10R. Specifically, the circuit diagram shows a configuration for three columns in the j-th group in the distribution circuit 50.

Although the switches 52a, 52b, and 52c are N-channel type transistors in FIG. 5, the switches 52a, 52b, and 52c are transmission gates in FIG. 15.

Accordingly, the on-state and the off-state of the switch 52a are controlled according to not only the control signal Sel(1) but also a control signal/Sel(1) having an inverted relationship with the logic level of the control signal Sel(1).

Similarly, the on-state and the off-state of the switch 52b are controlled according to control signals Sel(2) and/Sel(2), and the on-state and the off-state of the switch 52c are controlled according to control signals Sel(3) and/Sel(3).

A set of a NOT circuit L21 and a switch L22 is provided in one-to-one correspondence with the data line 114. In the first series as a representative, the input terminal of the NOT circuit L21 is coupled to a control line 16. The display control circuit 140 supplies a control signal Allx_on commonly to each column to the control line 16. The control signal Allx_on is at the H level in the unit periods Ttm of the odd frame (F_odd) and the even frame (F_even), and is at the L level in the other periods.

In the second embodiment, the control signals Sel(1) to Sel(3) are exclusively at the H level in order in one horizontal scanning period (H) in the first embodiment in the unit periods Rtm, Gtm, and Btm, but are all at the L level in the unit period Ttm.

Furthermore, the control signals /Sel(1) to /Sel(3) are exclusively at the L level in order in one horizontal scanning period (H) in the unit periods Rtm, Gtm, and Btm, but are all at the H level in the unit period Ttm.

The input terminal of the switch L22 which is a transmission gate is coupled to a control line 17. The display control circuit 140 applies the voltage Vwt(+) or Vwt(−) commonly to each column to the control line 17. Specifically, the display control circuit 140 applies the voltage Vwt(+) to the control line 17 in the unit period Ttm of the odd frame (F_odd) and applies the voltage Vwt(−) to the control line in the unit period Ttm of the even frame (F_even).

The on-state and the off-state of the switch L22 are controlled according to the control signal Allx_on. Specifically, the switch L22 in each column is in the on-state when the control signal Allx_on is at the H level, and is in the off-state when the control signal Allx_on is at the L level.

In the distribution circuit 50, the control signal Allx_on is at the L level and the switch L22 of each column is in the off-state in the unit periods Rtm, Gtm, and Btm, and thus the same operation as that in the first embodiment is performed.

In contrast, in the distribution circuit 50, in the unit period Ttm, the control signals Sel(1) to Sel(3) are at the L level, and the switches 52a, 52b, and 52c are in the off-state. In the unit period Ttm, the control signal Allx_on is at the H level, the switch L22 of each column is in the on-state. Therefore, in the unit period Ttm of the odd frame (F_odd), the voltage Vwt(+) is simultaneously applied to the data lines 114 of each column, and the voltage Vwt(−) is simultaneously applied thereto in the unit period Ttm of the even frame (F_even).

In the second embodiment, the control circuit 200 outputs the following control signal Vsig.

Specifically, as illustrated in FIG. 12, the control signal Vsig becomes the voltage Vwt(+) at the timing ts when the scanning line 112 of the first row is selected in the first half period of the unit period Ttm, that is, without waiting for the selection of the final scanning line 112 of the last m-th row.

In the second embodiment, the control signal becomes the voltage Vwt(−) by inverting the polarity at the timing at the half of the period Ltm, and becomes the voltage Vcom at the timing t3.

In the second embodiment, since the control signal Ally_on is at the H level at the timing ts when the unit period Ttm starts, the scanning signals Gwr(1) to Gwr(m) are simultaneously at the H level.

In contrast, since the control signal Allx_on is at the H level, the voltage Vwt(+) is simultaneously applied to the data line 114 of each column in the unit period Ttm of the odd frame (F_odd).

Accordingly, in the second embodiment, since the voltage Vwt(+) is applied as the data signal to all the pixel electrodes 118 in the liquid crystal panels 30L and 10R at the timing ts, the state in which the transmittance is maximized is achieved earlier than that in the first embodiment. In contrast, the state in which the transmittance is maximized ends at the timing td, which is unchanged as compared with the first embodiment.

Therefore, in the second embodiment, since the period Trtm not hatched in the drawing, that is, the period in which the user is allowed to visually recognize the real image as the outside view can be made longer than that in the first embodiment, the real image can be visually recognized lighter.

In the second embodiment, only the positive voltage Vwt(+) is applied to the liquid crystal elements 120 of the liquid crystal panels 10L and 10R in the unit period Ttm of the odd frame (F_odd). Therefore, in order to prevent the application of the DC component, the negative voltage Vwt(−) having the inverted polarity is applied to the liquid crystal elements 120 of the liquid crystal panels 10L and 10R in the unit period Ttm of the next even frame (F_even).

In the first embodiment, the modification of the first embodiment, and the second embodiment (hereinafter referred to as “the embodiments and the like”), various modifications or applications can be made as follows.

In the embodiments and the like, the liquid crystal panels 30L and 30R may be configured to drive the liquid crystal element 120 for each pixel in the same manner as the liquid crystal panels 10L and 10R, and a signal that maximizes the transmittance may be written in the pixels in the liquid crystal panels 30L and 30R in synchronization with writing in the liquid crystal panels 10L and 10R in the unit period Ttm.

Furthermore, the light emitting panels 20L and 20R may be configured to be driven for each pixel similarly to the liquid crystal panels 10L and 10R. When the light emitting panels 20L and 20R are driven for each pixel, so-called local dimming may be adopted. Specifically, the brightness of the color lights generated by the light emitting panels 20L and 20R may be adjusted according to the brightness of the color components in the video pixels visually recognized by the user in the liquid crystal panels 10L and 10R.

By adopting local dimming, the visual recognition of the video can be improved and the power consumption can be suppressed.

In the embodiments and the like, the color image is visually recognized by color sequential visual recognition of the color components of red, green, and blue in the unit periods Rtm, Gtm, and Btm, but an image of a single color component may be visually recognized not divisionally in the unit periods Rtm, Gtm, and Btm.

The liquid crystal panel 10L and the light emitting panel 20L, and the liquid crystal panel 10R and the light emitting panel 20R may each be configured with a self-emitting display panel, for example, a transmissive organic EL display panel, and the liquid crystal panels 30L and 30R may be provided at the opposite side to the eyes of the user with respect to the self-emitting display panels. In this configuration, the self-emitting display panel has both functions of the light emitting unit and the display unit.

In addition, since the liquid crystal panels 30L and 30R switch transmission or blocking of light, for example, mechanical shutters may be used instead.

The following configurations, for example, are figured out from the configurations exemplified above.

A virtual image display device according to one configuration 1 includes a light emitting unit that transmits a light from an outside world in a first period and emits a first color light in a second period, a display unit that transmits the light from the outside world transmitted through the light emitting unit in the first period, and generates a transmission image of the first color light emitted by the light emitting unit in the second period, and a transmission and blocking switching unit that transmits the light from the outside world in the first period, and blocks the first color light emitted from the light emitting unit in the second period.

According to the virtual image display device of the configuration 1, the user visually recognizes the outside view in the first period, and visually recognizes the transmission image by the display unit as a virtual image in the second period. In the second period, since the first color light emitted from the light emitting unit is blocked, it is possible to suppress the occurrence of the eye glow phenomenon.

The unit period Ttm is an example of the “first period”, and the unit period Rtm is an example of the “second period”. The red light is an example of the “first color light”, the light emitting panel 20L is an example of the “light emitting unit”, the liquid crystal panel 10L is an example of the “display unit”, and the liquid crystal panel 10L is an example of the “transmission and blocking switching unit”.

In a virtual image display device according to a specific configuration 2 of the configuration 1, the first period and the second period are alternately repeated. According to the virtual image display device of the configuration 2, the user can visually recognize the virtual image in the transmission image superimposed on the visual recognition of the outside view in the first period.

In a virtual image display device according to a specific configuration 3 of the configuration 1, the display unit, the light emitting unit, and the transmission and blocking switching unit are sequentially arranged in a direction toward the outside world. According to the virtual image display device of the configuration 3, an appropriate arrangement of the display unit, the light emitting unit, and the transmission and blocking switching unit is implemented.

In a virtual image display device according to another specific configuration 4 of the configuration 1, in the second period, the light emitting unit time-divisionally emits the first color light, a second color light, and a third color light, the transmission and blocking switching unit blocks the first color light, the second color light, and the third color light emitted from the light emitting unit, and the display unit time-divisionally generates a transmission image of the first color light, a transmission image of the second color light, and a transmission image of the third color light.

According to the virtual image display device of the configuration 4, the user can visually recognize a color virtual image. The green light is an example of the “second color light”, and the blue light is an example of the “third color light”.

In a virtual image display device according to a specific another configuration 5 of the configuration 1, the display unit includes a plurality of display pixels, and the plurality of display pixels generate the transmission image by vertical scanning and horizontal scanning in the second period.

According to the virtual image display device of the configuration 5, the transmission image is generated by the plurality of display pixels in the second period. The pixel circuit 110 is an example of the “display pixel”.

In a virtual image display device according to a specific configuration 6 of the configuration 5, the plurality of display pixels simultaneously transmits the light from the outside world in the first period. According to the virtual image display device of the configuration 6, since the light from the outside world is simultaneously transmitted in the first period, the virtual image display device shifts to the transmissive state in a shorter time as compared with the case where the light is transmitted in the horizontal scanning and the vertical scanning. Therefore, it is possible to lengthen the period in which the light in the outside world is visually recognized in the first period.

What is claimed is:

1. A virtual image display device, comprising:
a light emitting unit that is configured to transmit a light from an outside world in a first period and emit a first color light in a second period;
a display unit that is configured to transmit the light from the outside world transmitted through the light emitting unit in the first period, and generate a transmission image of the first color light emitted by the light emitting unit in the second period; and
a transmission and blocking switching unit that is configured to transmit the light from the outside world in the first period, and block the first color light emitted from the light emitting unit in the second period.

2. The virtual image display device according to claim 1, wherein
the first period and the second period are alternately repeated.

3. The virtual image display device according to claim 1, wherein
the display unit, the light emitting unit, and the transmission and blocking switching unit are sequentially arranged in a direction toward the outside world.

4. The virtual image display device according to claim 1, wherein
in the second period, the light emitting unit time-divisionally emits the first color light, a second color light, and a third color light, the transmission and blocking switching unit blocks the first color light, the second color light, and the third color light emitted from the light emitting unit, and the display unit time-divisionally generates a transmission image of the first color light, a transmission image of the second color light, and a transmission image of the third color light.

5. The virtual image display device according to claim 1, wherein
the display unit includes a plurality of display pixels, and
the plurality of display pixels is configured to generate the transmission image by vertical scanning and horizontal scanning in the second period.

6. The virtual image display device according to claim 5, wherein
the plurality of display pixels is configured to simultaneously transmit the light from the outside world in the first period.
